(19) United States
(12) Patent Application Publication
(10) Pub. No.: US 2019/0118882 A1
(43) Pub. Date: Apr. 25, 2019

(54) HYDRAULIC OPERATING SYSTEM FOR TRAILER AXLE

(71) Applicant: LIPPERT COMPONENTS, INC., Elkhart, IN (US)

(72) Inventors: Mark Kinder, Clarks Hill, IN (US); Bruce A. Bailey, Bristol, IN (US); Phillip Heiner, Middlebury, IN (US)

(21) Appl. No.: 16/168,243

(22) Filed: Oct. 23, 2018

Related U.S. Application Data
(60) Provisional application No. 62/575,736, filed on Oct. 23, 2017.

(51) Int. Cl. B62D 61/12; B60G 5/00

(52) U.S. Cl. CPC B62D 61/125; B60G 17/005; B60G 5/00

(57) ABSTRACT

A hydraulic system includes an actuator having an extend chamber and a retract chamber, a hydraulic reservoir, a hydraulic pump, and a hydraulic control valve. The control valve is configurable among a first alignment in which it aligns the pump with the extend chamber and the reservoir with the retract chamber, a second alignment in which it aligns the pump with the extend chamber and isolates the retract chambers from the reservoir, and a third alignment in which it aligns the pump with the retract chamber and the reservoir with the extend chamber. A hydraulic accumulator is hydraulically coupled to the retract chamber.

### CROSS-REFERENCE TO RELATED APPLICATION

This application claims benefit under 35 U.S.C. § 119 of U.S. Provisional Patent Application No. 62/575,736, filed on Oct. 23, 2017, and incorporates by reference the disclosure thereof in its entirety. Any discrepancy between the foregoing disclosure and this disclosure shall be reconciled in favor of this disclosure.

### BACKGROUND AND SUMMARY OF THE DISCLOSURE

It is known to provide a trailer with an operating system that varies the orientation of the trailer bed with respect to the trailer axle or axles. This feature allows a user to vary the inclination of the trailer frame with respect to the ground, thereby allowing loading and unloading of the trailer without ramps.

A hydraulic actuator may be used as a prime mover for driving the operating mechanism between a first (or travel) configuration and a second (or loading) configuration. The hydraulic actuator also may serve to maintain the mechanism in the travel configuration once placed there. Use of the hydraulic actuator to maintain the operating system in the travel configuration, however, can result in repeated, if minute, oscillation of the actuator's piston with respect to its cylinder while the trailer is in transit in response to pressure undulations imparted thereto, for example, due to interaction of the trailer and its wheels and axles with all forms of road irregularities. The seals between the actuator's piston and cylinder are subjected to this oscillation and they tend to wear out prematurely as result.

### BRIEF DESCRIPTION OF THE DRAWINGS

FIG. 1 is a perspective view of a trailer connected to a tow vehicle, the trailer having a frame, a subframe connected to the frame, first and second axles connected to the subframe, and an operating mechanism connected to the subframe, the operating mechanism including an actuator and being configured to vary the height of the trailer's axles with respect to the trailer's frame;

FIG. 2 is a side elevation view of the trailer and tow vehicle of FIG. 1, with the trailer, the axles, and the operating mechanism in a first (or travel) configuration;

FIG. 3 is a side elevation view of the trailer and tow vehicle of FIG. 1, with the trailer, the axles, and the operating mechanism in a second (or loading) configuration;

FIG. 4 is a perspective view of the subframe, axles, and operating mechanism of the trailer of FIG. 1 in the first configuration, and with the wheels and tires removed for clarity;

FIG. 5 is a side elevation view of the subframe and operating mechanism of the trailer of FIG. 1 in the first configuration, and with the wheels and tires removed for clarity;

FIG. 6 is a side elevation view of the subframe and operating mechanism of the trailer of FIG. 1 in the second configuration, and with the wheels and tires removed for clarity;

FIG. 7 is a schematic representation of a hydraulic system for driving the actuator of the operating mechanism of FIGS. 1 and 2; and

FIG. 8 is a perspective view of an alternative subframe and operating mechanism of the trailer of FIG. 1.

### DETAILED DESCRIPTION OF THE DRAWINGS

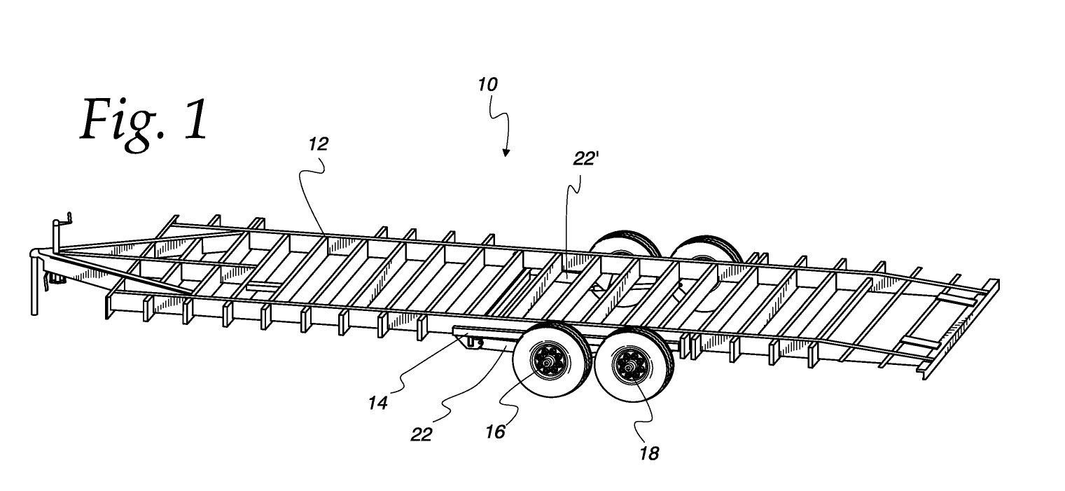

FIG. 1 shows a trailer 10 having a frame 12, a subframe 14, first and second axles 16, 18, a first operating mechanism 22 connected to respective first ends of the first and second axles, and a second operating mechanism 22′ connected to respective second ends of the first and second axles. The first and second operating mechanisms 22, 22′ are operable to selectively displace the respective first and second ends of the first and second axles 16, 18 with respect to the frame 12 and the subframe 14, to thereby vary the height of the first and second axles with respect to the subframe and the frame. The first and second operating mechanisms 22, 22′ may be identical to or mirror images of each other, and they may operate in the same manner. As such, only the first operating mechanism 22 will be described in detail herein.

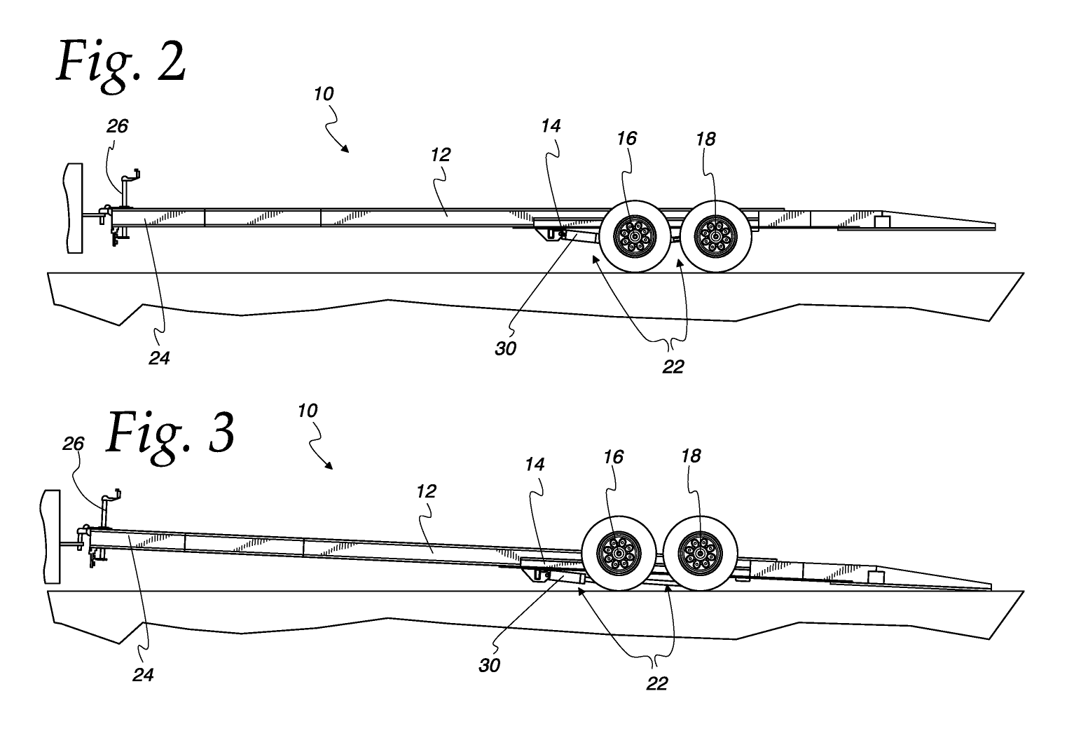

FIG. 2 shows the trailer 10 connected to a tow vehicle V, with the first and second axles 16, 18 and the first and second operating mechanisms 22, 22′ in a first (or travel) configuration, in which the trailer is configured for towing by the tow vehicle. In the travel configuration, the first and second axles 16, 18 are positioned relatively low with respect to the frame 12, and the trailer frame 12 is positioned in a first inclination with respect to the ground underneath the trailer. As shown, the first inclination may be substantially parallel to the ground underneath the trailer.

FIG. 3 shows the trailer 10 connected to a tow vehicle V, with the first and second axles 16, 18 and the first and second operating mechanisms 22, 22′ in a second (or loading) configuration, in which the trailer is configured for ease of loading and unloading. In the loading configuration, the first and second axles 16, 18 are positioned relatively high with respect to the frame 12, and the frame 12 is positioned in a second inclination with respect to the ground underneath the trailer. As shown, the second inclination may be great enough that the trailing end of the trailer contacts or is proximate the ground underneath the trailer.

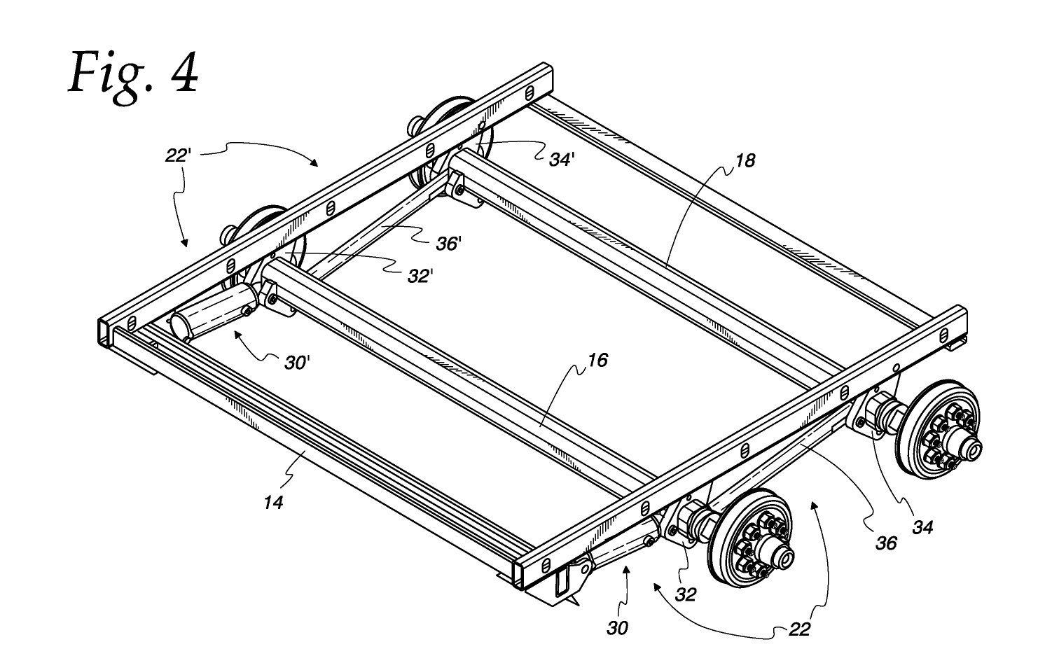

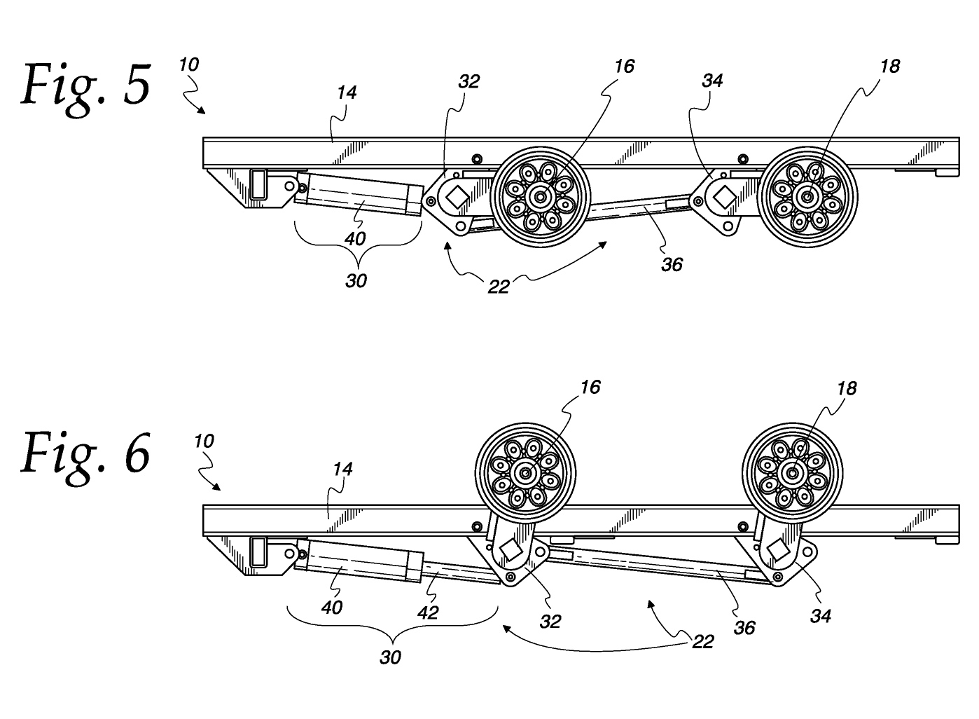

FIGS. 4-6 show the subframe 14, the first and second axles 16, 18, and the first operating mechanism 22 in greater detail, with the wheels and tires omitted for clarity (FIG. 4 further shows the second operating mechanism 22′). FIGS. 4 and 5 show the subframe 14, the first and second axles 16, 18, and the first operating mechanism 22 in the first configuration (FIG. 3 further shows the second operating mechanism 22′ in the first configuration). FIG. 6 shows the subframe 14, the first and second axles 16, 18, and the first operating mechanism 22 in the second configuration.

As mentioned above, the operating mechanism 22 is configured to vary the orientation of the first and second axles 16, 18 with respect to the subframe 14. With the tongue 24 of the trailer 10 connected to and supported by the hitch of the tow vehicle V (or supported by a tongue jack 26), such variation in the orientation of the axles 16, 18 with respect to the frame 12 causes variation in the inclination of the trailer frame 12 (and a trailer bed that may be carried thereon) with respect to the ground underneath the trailer. The operating mechanism 22 may include mechanical travel stops (not shown) limiting its travel and, therefore, the displacement of the first and second axles 16, 18 to a predetermined range. More specifically, the operating system 22 may include a first travel stop precluding the operating mechanism from displacing the first and second axles 16, 18 beyond the first configuration when the operating mechanism is operated in a first direction, and a second travel stop precluding the operating mechanism from displacing the first and second axles 16, 18 beyond the second configuration when the operating mechanism is operated in a second direction.

The first operating mechanism 22 includes an actuator 30, for example, a hydraulic or pneumatic actuator, configured as a prime mover for actuating the operating mechanism. The first operating mechanism 22 also includes a first pivoting axle carrier 32 pivotally connected to the subframe 14 at a first pivot point and carrying the first axle 16, a second pivoting axle carrier 34 pivotally connected to the subframe 14 at a second pivot point and carrying the second axle 18, and a link 36 pivotally connected to each of the pivoting axle carriers 32, 34. The actuator 30 is operable to selectively pivot the first pivoting axle carrier 32 with respect to the subframe 14 about the first pivot point. Such pivoting of the first pivoting axle carrier 32 causes displacement of the link 36 which, in turn, causes pivoting of the second pivoting axle carrier 34 with respect to the subframe 14 about the second pivot point.

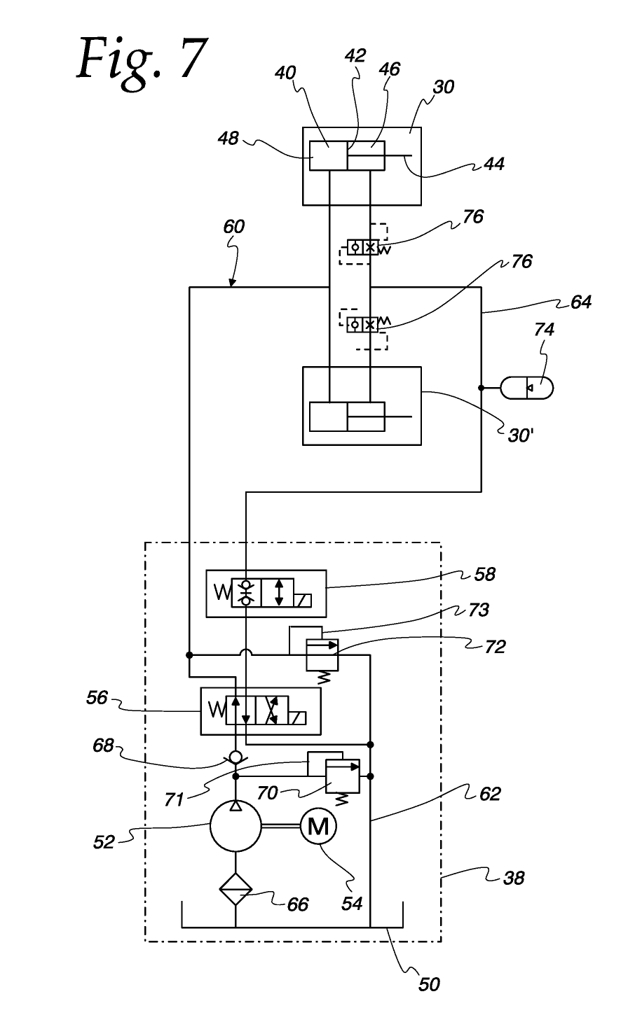

FIG. 7 is a schematic diagram of a hydraulic system 38 for operating the actuators 30, 30′ of the first and second operating mechanism 22, 22′. Each of the actuators 30, 30′ may be identical. As such, only the actuator 30 will be described in detail herein. The actuator 30 includes a cylinder 40, a piston 42 slidingly received within the cylinder, and a piston rod 44 connected to a first (or rod) side of the piston. The cylinder 40 and the rod side of the piston 42 cooperate to define a retract chamber 46. The cylinder 40 and a second (or non-rod) side of the piston 42 cooperate to define an extend chamber 48. Each of the actuators 30 also may include one or more seals (not shown) disposed circumferentially between the cylinder 40 and the piston 42 to effectively isolate the retract chamber 46 from the extend chamber 48. The seals may be received, for example, in a circumferential groove disposed about the periphery of the piston 42 or in a circumferential groove disposed about the bore of the cylinder 40.

The hydraulic system 38 includes a fluid reservoir 50, a hydraulic pump 52 having an inlet hydraulically coupled to the reservoir and an outlet, a motor 54 (for example, an electric motor) configured to selectively operate the hydraulic pump 52, a first control valve 56, and a second control valve 58.

The first control valve 56 is reconfigurable between a first configuration and a second configuration. In the first configuration (as shown in FIG. 7), the first control valve 56 hydraulically couples the outlet of the pump 52 with the extend chambers 48 of the actuators 30, 30′ via an extend line 60, and it hydraulically couples the second control valve 58 with the reservoir 50 via a reservoir return line 62. In the second configuration, the first control valve 56 hydraulically couples the outlet of the pump 52 with the second control valve 58, and it hydraulically couples the extend chambers 48 of the actuators 30, 30′ with the reservoir 50 via the reservoir return line 62.

The second control valve 58 also is reconfigurable between a first configuration and a second configuration. In the first configuration (as shown in FIG. 7), the second control valve 58 hydraulically isolates the retract chambers 46 of the actuators 30, 30′ from the first control valve 56. In the second configuration, the second control valve 58 hydraulically couples the retract chambers 46 of the actuators 30, 30′ with the first control valve 56 via a retract line 64.

With the first control valve 56 in its first configuration and the second control valve 58 in its first configuration, the outlet of the pump 52 is hydraulically coupled to the extend chambers 48 of the actuators 30, 30′, and the retract chambers 46 of the actuators 30, 30′ are hydraulically connected to each other and to an accumulator 74, as will be discussed further below, but otherwise are hydraulically isolated from the rest of the hydraulic system 38. This configuration of the first and second control valves 56, 58 may be referred to herein as the first valve alignment.

With the first control valve 56 in its first configuration and the second control valve 58 in its second configuration, the outlet of the pump 52 is hydraulically coupled to the extend chambers 48 of the actuators 30, 30′, and the retract chambers 46 of the actuators 30, 30′ are hydraulically coupled to the reservoir 50. This configuration of the first and second control valves 56, 58 may be referred to herein as the second valve alignment.

With the first control valve 56 in its second configuration and the second control valve 58 in its second configuration, the outlet of the pump 52 is hydraulically coupled to the retract chambers 46 of the actuators 30, 30′, and the extend chambers 48 of the actuators 30, 30′ are hydraulically coupled to the reservoir 50. This configuration of the first and second control valves 56, 58 may be referred to herein as the third valve alignment.

With the first control valve 56 in its second configuration and the second control valve 58 in its first configuration, the outlet of the pump 52 is hydraulically isolated from the actuators 30, 30′. This configuration of the first and second control valves 56, 58 may be referred to herein as the fourth valve alignment.

In an embodiment, the first control valve 56 and the second control valve 58 could be embodied as a single hydraulic control unit reconfigurable to provide the four valve alignments discussed above or the hydraulic equivalents thereof.

The hydraulic system 38 may further include a strainer 66 hydraulically coupled between the reservoir 50 and the pump 52, a check valve 68 hydraulically coupled between the pump 52 and the extend chambers first control valve 56, a first pressure relief valve 70 hydraulically coupled between the pump 52, the check valve 68, and the reservoir 50, and a second pressure relief valve 72 hydraulically coupled between the first control valve 56, the extend chambers 48, and the reservoir 50.

Either or both of the first relief valve 70 and the second relief valve 72 may be pilot-operated and may have an adjustable set point. If the first relief valve 70 is pilot-operated, a pilot line 71 may be hydraulically coupled between the pump 52, the check valve 68, and the first relief valve. If the second relief valve 72 is pilot-operated, a pilot line 73 may be hydraulically coupled between the first control valve 56, the extend chambers 48, and the second relief valve.

An accumulator 74 is provided in fluid communication with the retract chambers 46 of the actuators 30, 30′. The accumulator 74 is configured to selectively maintain the retract chambers 46 of the actuators 30, 30′ at a predetermined pressure or range of pressures at least when the trailer 10 is in transit or is in the travel configuration. The accumulator 74 may be, for example, a nitrogen-charged accumulator having a hydraulic fluid side and a charge side. The hydraulic fluid side may be hydraulically coupled to the retract line 64 or otherwise to the retract chambers 46. The charge side may be charged with nitrogen at a predetermined pressure, for example, half the hydraulic system operating pressure. In an embodiment, the hydraulic system operating pressure could be about 2000 psi and the charge pressure could be about 1000 psi.

In use, the piston rods 44 of the actuators 30, 30′ may be extended from the respective cylinders 40 thereof to place the operating mechanisms 22, 22′ into the loading configuration, and the piston rods may be retracted into the cylinders to place the operating mechanisms into the travel configuration.

The piston rods 44 may be extended from the cylinders 40 by configuring the first control valve 56 and the second control valve 58 in the second valve alignment discussed above. With the first and second control valves 56, 58 so configured, the pump 52 may be operated to withdraw hydraulic fluid from the reservoir 50 and provide pressurized hydraulic fluid to the extend chambers 48 through the check valve 68 via the extend line 60. The admission of pressurized hydraulic fluid to the extend chambers 48 causes the pistons 42 to be displaced to extend the piston rods 44 from the cylinders 40 and to decrease the volume of the retract chambers 46, thereby causing hydraulic fluid to flow from the retract chambers, through the retract line 64 and the first and second control valves 56, 58, to the reservoir 50.

The pump 52 may be operated until the piston rods are fully extended from the cylinders 40 or until the piston rods reach full extension (as may be limited by the first travel stops of the operating mechanisms 22, 22′) (either state may be referred to herein as full extension of the piston rod). Once the piston rods 44 have reached full extension, further travel of the pistons 42 with respect to the cylinders 40 is precluded, so that the extend chambers 48 cannot receive further hydraulic fluid. As such, continued operation of the pump 52 causes the hydraulic fluid pressure in the extend line 60 (sometimes referred to herein as the extend line pressure) to increase above the normal hydraulic system operating pressure (which may be, for example, about 2000 psi). If the extend line pressure exceeds the set point of the first pressure relief valve 70, the first pressure relief valve will open to relieve hydraulic fluid from the extend line 60 to the reservoir 50. Similarly, if the extend line pressure exceeds the set point of the second pressure relief valve 72, the second pressure relief valve will open to relieve hydraulic fluid from the extend line 60 to the reservoir 50.

The pump 52 may be stopped at any time during the extend operation, for example, before the piston rods 44 reach full extension, when the piston rods reach full extension, or after the piston rods reach full extension. When the pump 52 is stopped, the check valve 68 closes to preclude backflow of hydraulic fluid from the extend line 60 or extend chambers 48 to the reservoir 50 through the pump 52.

Also, the second control valve 58 may be placed into its second configuration at any time. When the second control valve 58 in its second configuration, it isolates the retract line 64 from the reservoir 50, thereby precluding further relief of hydraulic fluid from the retract line.

If the second control valve 58 is placed into its second configuration with the pump 52 running, the pressure in the extend line 60 may increase above the set point of the first pressure relief valve 70, causing the first pressure relief valve to open to relieve hydraulic fluid from the extend line 60 to the reservoir 50. The pressure in the extend line 60 also may increase above the set point of the second pressure relief valve 72, causing the second pressure relief valve to open to relieve hydraulic fluid from the extend line 60 to the reservoir 50.

The piston rods 44 may be retracted by configuring the first control valve 56 and the second control valve 58 in the third valve alignment discussed above. With the first and second control valves 56, 58 so configured, the pump 52 may be operated to withdraw hydraulic fluid from the reservoir 50 and provide pressurized hydraulic fluid to the retract chambers 46 via the check valve 68 and the retract line 64. The admission of pressurized hydraulic fluid to the retract chambers 46 causes the piston 42 to be displaced to retract the piston rod 44 into the cylinder 40 and to decrease the volume of the extend chambers 48, thereby causing hydraulic fluid to flow from the extend chambers, through the extend line 60 and to the reservoir 50.

The pump 52 may be operated until the piston rods 44 are fully retracted into the cylinders 40 or until the piston rods reach full retraction as may be limited by the second travel stops of the operating mechanisms 22, 22′ (either state may be referred to herein as full retraction of the piston rods). Once the piston rods 44 have reached full retraction, further travel of the pistons 42 with respect to the cylinders 40 is precluded, so that the retract chambers 46 cannot receive further hydraulic fluid.

Continued operation of the pump 52 with the piston rods 44 fully retracted and with the first and second control valves 56, 58 so configured results in limited continued flow of pressurized hydraulic fluid into the retract line 64 and the hydraulic side of the accumulator 74. Once the hydraulic side of the accumulator 74 is filled or partially filled with hydraulic fluid, the second control valve 58 may be configured in its second configuration to isolate the hydraulic control system 38 from the retract line 64, the accumulator 74, and the retract chambers 46, and the pump 52 may be stopped.

If the pump 52 is allowed to continue operating with the retract line 64, the accumulator 74, and the retract chambers 46 so isolated, the pump outlet line pressure will increase. If the pump outlet line pressure exceeds the set point of the first pressure relief valve 70, the first pressure relief valve will open and relieve hydraulic fluid from the extend line 60 to the reservoir 50.

The pump 52 may be stopped at any time during the retract operation, for example, before the piston rods 44 reaches full retraction, when the piston rods reach full retraction, or after the piston rods have reached full retraction. When the pump 52 is stopped, the check valve 68 closes to preclude backflow of hydraulic fluid from the retract line 64 or retract chambers 46 to the reservoir 50 through the pump 52.

As suggested above, an overpressure condition on either the retract side or extend side of the hydraulic system may be mitigated by relieving hydraulic fluid from the extend side of the system to the reservoir 50 through the second pressure relief valve 72. Such an overpressure condition could be created by allowing the pump 52 to continue running after the operating mechanisms 22, 22′ have transitioned to the travel configuration, and/or if the accumulator 74, the retract line 64, and the retract chambers 46 are subjected to an abnormal load subjecting them to pressurize greater than a predetermined overpressure.

Once the piston rods 44 have retracted sufficiently to place the operating mechanisms 22, 22′ into the travel configuration, the pump 52 is stopped. If the pump 52 is allowed to continue operating, the first relief valve 70 may open to relieve hydraulic fluid to the reservoir 50 to mitigate an overpressure condition in the retract line between the pump and the check valve 68. With the pump 52 stopped, the check valve 68 precludes backflow of hydraulic fluid therethrough from the retract chambers 46 to the reservoir 50.

With the piston rods 44 fully retracted, and the retract line 64 isolated as set forth above (that is, with the second control valve 58 in its first configuration), the accumulator 74 maintains sufficient pressure in the retract line to preclude the pistons 42 from oscillating with respect to the cylinders 40 in response to loads imparted to the wheels while the trailer is towed or otherwise in motion, even in the event of minor hydraulic fluid leakage past the actuator seal(s) and/or the interface between the plug (or spool) and seat of the second control valve 58.

In an alternate embodiment, the orientation of the actuators 30, 30′ could be reversed with respect to the hydraulic control system 38, and the piston rods 44 could be extended to place the operating system into the travel configuration and retracted to place it into the loading configuration. In such an embodiment, the accumulator 74 would be analogously hydraulically coupled to the extend line 60 or otherwise to the extend chambers 48 instead of to the retract line 64 and the retract chambers 46.

A velocity fuse 76 may be provided in the retract line 64 proximate each of the retract chambers 46. In the event the retract line 64 were to burst on the reservoir side of the velocity fuses 76, thereby causing a condition under which the retract chambers 46 could rapidly lose hydraulic fluid through the retract line and depressurize, the velocity fuses 76 would close to arrest such flow of fluid from and depressurization of the retract chambers.

The operating mechanism 22 may be configured so that the first and/or second travel stop is reached without the piston 44 extending or retracting fully to the respective ends of the cylinder 40, thereby limiting the stroke of the pistons with respect the cylinders.

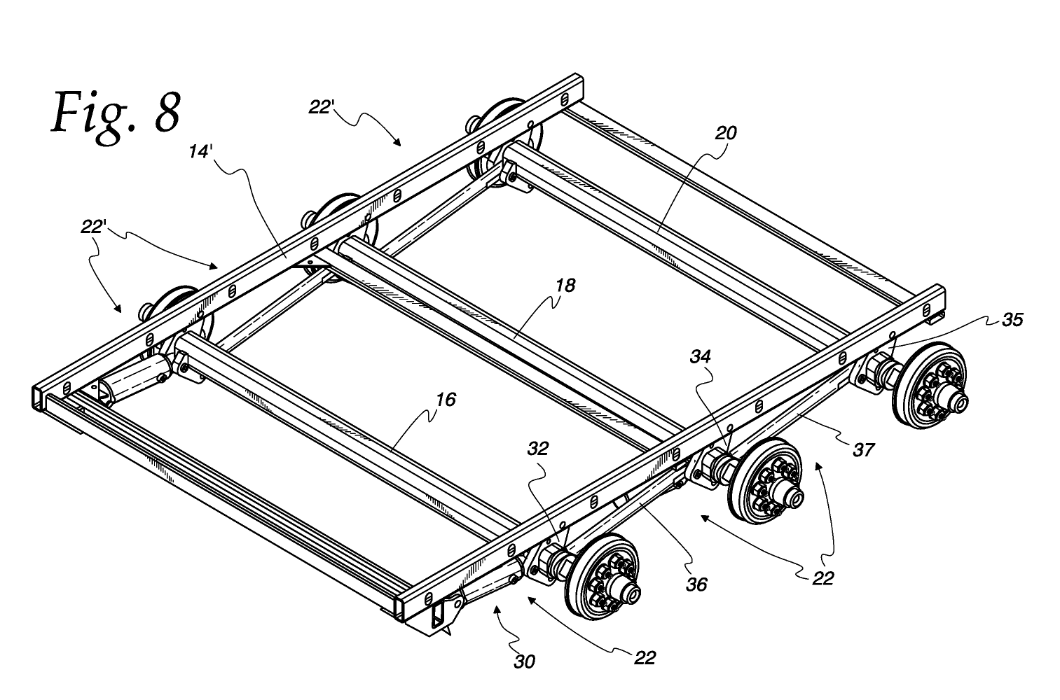

FIG. 8 shows an alternative embodiment including a subframe 14′ and first and second axles 16, 18 pivotably connected thereto by first and second pivoting axle carriers 32, 34, respectively, as described above. The FIG. 8 embodiment also include a third axle 20 pivotably connected to the subframe 14′ by a third pivoting axle carrier 35. In this embodiment, the operating mechanisms 20, 20′ are identical to those described above, except that they further include a second link 37 pivotably connected to the second pivoting axle carrier 34 and to the third pivoting axle carrier 35. The second link 37 is operable to pivot the third pivoting axle carrier 35 in response to pivoting of the second axle carrier.

In an embodiment, the second axle 18 and related components could be omitted.

In another embodiment, the subframe 14 could be omitted and the axle carriers and operating mechanisms could be connected directly to the trailer frame 12.

Certain illustrative embodiments are shown and described herein. Features shown and described in connection with a given embodiment may be included in any other embodiment to the greatest extent possible. The embodiments may be readily modified without departing from the scope of the appended claims and, therefore, shall not be construed to limit the scope of the invention as defined thereby.

1. A hydraulic system comprising:
a first hydraulic actuator having an extend chamber and a retract chamber;
a second hydraulic actuator having an extend chamber and a retract chamber;
a hydraulic accumulator hydraulically coupled to the retract chambers of each of the first and second actuators;
a hydraulic fluid reservoir;
a hydraulic pump having an inlet hydraulically coupled with the reservoir and an outlet;
a hydraulic control unit hydraulically coupled to the pump, to the reservoir, to the extend chamber and the retract chamber of each of the first actuator and the second actuator, the hydraulic control unit reconfigurable among:
a first alignment in which the pump outlet is hydraulically coupled to the extend chambers of the first and second actuators, in which the retract chambers of the first and second actuators are hydraulically coupled to each other and to the accumulator, and in which the retract chambers of the first and second actuators and the accumulator are hydraulically isolated from the pump and the reservoir;
a second alignment in which the pump outlet is hydraulically coupled to the extend chambers of the first and second actuators, and in which the retract chambers of the first and second actuators and the accumulator are hydraulically coupled to the reservoir;
a third configuration in which the pump outlet is hydraulically coupled to the retract chambers of the first and second actuators, and in which the extend chambers of the first and second actuators are hydraulically coupled to the reservoir; and
a fourth configuration in which the pump is hydraulically isolated from the extend and retract chambers of the first and second actuators.

2. The hydraulic system of claim 1, wherein the hydraulic control unit comprises a first control valve and a second hydraulic control valve.

3. The hydraulic system of claim 2,
wherein the first hydraulic control valve is reconfigurable between
a first configuration in which the pump outlet is hydraulically coupled to the extend chambers of the first and second hydraulic actuators, and in which the second hydraulic control valve is hydraulically coupled to the reservoir, and
a second configuration in which the pump outlet is hydraulically coupled to the second control valve, and in which the extend chambers of the first and second hydraulic actuators are hydraulically coupled to the reservoir; and
wherein the second hydraulic control valve is reconfigurable between
a first configuration in which the retract chambers of the first and second hydraulic actuators and the accumulator are hydraulically connected to each other and hydraulically isolated from the first control valve, and
a second configuration in which the retract chambers of the first and second hydraulic actuators and the accumulator are hydraulically coupled to the first hydraulic control valve.

4. The hydraulic system of claim 3 wherein
the hydraulic control unit is in the first alignment when the first control valve is in its first configuration and when the second control valve is in its first configuration,
the hydraulic control unit is in the second alignment when the first control valve is in its first configuration and when the second control valve is in its second configuration,
the hydraulic control unit is in the third alignment when the first control valve is in its second configuration and when the second control valve is in its second configuration,
the hydraulic control unit is in the fourth alignment when the first control valve is in its second configuration and when the second control valve is in its first configuration.

5. The hydraulic system of claim 1 further comprising a first velocity fuse hydraulically connected in series between the retract chamber of the first hydraulic actuator and the hydraulic accumulator, and a second velocity fuse hydraulically connected in series between the retract chamber of the second hydraulic actuator and the hydraulic accumulator.

6. The hydraulic system of claim 1 in combination with a trailer having a frame and a first axle pivotably connected to the frame, the first and second actuators connected to the first axle and the frame, and operable to selectively pivot the first axle with respect to the frame.

7. The combination of claim 7, the trailer further having a second axle pivotably connected to the frame, the combination further comprising a link pivotably connecting the first axle to the second axle so that the first and second actuators further are operable to selectively pivot the second axle with respect to the frame.

8. The hydraulic system of claim 1 in combination with a subframe and a first axle pivotably connected to the subframe, the first and second actuators connected to the first axle and the subframe, and operable to selectively pivot the first axle with respect to the subframe.

9. The combination of claim 8 further comprising a second axle pivotably connected to the subframe and a link pivotably connecting the first axle to the second axle so that the first and second actuators further are operable to selectively pivot the second axle with respect to the subframe.

10. A system for pivotably repositioning an axle of a trailer between first and second positions with respect to a frame of the trailer, the system comprising:
a hydraulic actuator connectable to the frame and to the axle, the hydraulic actuator having an extend chamber and a retract chamber;
a hydraulic accumulator hydraulically coupled to the retract chamber;
a hydraulic fluid reservoir;
a hydraulic pump having an inlet hydraulically coupled with the reservoir and an outlet; and
a hydraulic control unit hydraulically coupled to the pump, to the reservoir, to the extend chamber and the retract chamber, the hydraulic control unit reconfigurable among:
a first alignment in which the pump outlet is hydraulically coupled to the extend chamber, and in which the retract chamber is hydraulically coupled to the accumulator and hydraulically isolated from the pump and the reservoir;
a second alignment in which the pump outlet is hydraulically coupled to the extend chamber, and in which the retract chamber and the accumulator are hydraulically coupled to the reservoir;
a third configuration in which the pump outlet is hydraulically coupled to the retract chamber and the accumulator, and in which the extend chamber is hydraulically coupled to the reservoir; and
a fourth configuration in which the pump outlet is hydraulically isolated from the extend chamber and from the retract chamber.

11. The hydraulic system of claim 10 further comprising a velocity fuse hydraulically connected in series between the retract chamber and the hydraulic accumulator.

12. The system of claim 10 in combination with the trailer, wherein the axle is pivotable connected to the frame, wherein the actuator is pivotably connected to the first axle and to the frame, and wherein the actuator is operable to selectively pivot the first axle with respect to the frame.

13. The combination of claim 12, the trailer further having a second axle pivotably connected to the frame, the combination further comprising a link pivotably connecting the first axle to the second axle so that the actuator further is operable to selectively pivot the second axle with respect to the frame.

14. The combination of claim 13, the trailer further having a third axle pivotably connected to the frame, the combination further comprising a second link pivotably connecting the second axle to the third axle so that the actuator further is operable to selectively pivot the third axle with respect to the frame.

15. The system of claim 10 in combination with a subframe configured for connection to the trailer, wherein the axle is pivotable connected to the subframe, wherein the actuator is pivotably connected to the first axle and to the subframe, and wherein the actuator is operable to selectively pivot the first axle with respect to the subframe.

16. The combination of claim 15 further comprising a second axle pivotably connected to the subframe, the combination further comprising a link pivotably connecting the first axle to the second axle so that the actuator further is operable to selectively pivot the second axle with respect to the subframe.
